(19) United States
(12) Patent Application Publication
(10) Pub. No.: US 2022/0123844 A1
(43) Pub. Date: Apr. 21, 2022

(54) METHOD AND APPARATUS FOR SIGNAL REGENERATION

(71) Applicant: The Secretary of State for Defence, Salisbury, Wiltshire (GB)

(72) Inventors: Paul Mason, Salisbury, Wiltshire (GB); Stephen John Boyes, Salisbury, Wiltshire (GB); Jehan Jayanetti, Salisbury, Wiltshire (GB)

(21) Appl. No.: 17/427,886

(22) PCT Filed: Jan. 31, 2020
(86) PCT No.: PCT/GB2020/000005

§ 371 Date: Aug. 2, 2021

(30) Foreign Application Priority Data
Feb. 11, 2019 (GB) 1901877.9

(51) Int. Cl. H04B 17/00; H04B 17/26; H04B 17/318; H04B 17/391

(52) U.S. Cl. CPC H04B 17/0085; H04B 17/3911; H04B 17/318; H04B 17/26

(57) ABSTRACT

A method (10) of regenerating a signal is provided. The method involves sampling (13) a received signal to obtain a plurality of samples each having an associated magnitude. The samples are sorted (15) to obtain a statistical distribution (which may be a histogram). Known distributions are fitted to the statistical distribution using a fitting operation (16, 17), and for each a measure of similarity is obtained. A matched distribution is then determined from the measures of similarity (18), that is subsequently used to regenerate a signal (12) that itself is statistically representative of the originally sampled signal. Such a method mitigates the storage burden associated with the recording and subsequent regeneration of representative wireless signal environments for wireless device testing. Also relates to an apparatus for the same.

### TECHNICAL FIELD OF THE INVENTION

This invention relates to the field of signal regeneration, in particular to methods and apparatus for regenerating statistically representative electromagnetic signals.

### BACKGROUND TO THE INVENTION

Over the air communications equipment is required to operate in electromagnetic environments that are increasingly becoming contested with signal transmissions. Communications equipment under development must be shown to function in such environments in order to be deemed fit for purpose. These assurances can be achieved by trialling a piece of equipment in the field, but such trials can be costly and uncontrollable with respect to changing ambient conditions.

An alternative solution is to use signal capture devices such as signal analysers to record a representative electromagnetic environment over time, the time based waveforms subsequently being played back to a unit under test in an appropriate over the air laboratory test configuration. Such an approach has inherent limitations—notably that there are legal constraints on the use of signal data recorded in certain jurisdictions, and the storage requirements for recording signal background in a contested electromagnetic environment is significant. Indeed the recording and playback of any statistically varying signal is inherently limited by available storage capacity on the recording device.

Therefore it is an aim of the present invention to provide an alternative method and apparatus for regenerating a statistically representative signal.

### SUMMARY OF THE INVENTION

According to a first aspect of the invention there is provided a method of regenerating a signal, comprising the steps of sampling a received signal to obtain a plurality of samples each having an associated magnitude; sorting the samples to obtain a statistical distribution of the magnitudes; fitting a plurality of known distributions to the statistical distribution using a fitting operation, and in each case obtaining a measure of similarity; determining a matched distribution from the plurality of known distributions, the matched distribution corresponding to an optimum value of the measure of similarity; synthesising a regenerated signal using the matched distribution; and then outputting the regenerated signal. The magnitude of a signal when sampled will vary from sample to sample as a result of the signal environment in which the signal is being transmitted. For instance this can be the result of multipath effects in a wireless signal environment. The inventors have shown that profiling received signal magnitude over time, and fitting known statistical distributions to the profiled data, allows a signal to be synthesised that statistically matches the original complex received signal, without requiring direct storage of a time varying received signal for subsequent playback. This allows a wireless receiver to be tested in the laboratory in a representative signal environment. This may also mitigate some issues concerning recording of wireless signals, because the actual received signal is not being recorded, instead its statistical behaviour is recorded and used to regenerate a statistically representative signal. Furthermore the storage burden can be significantly reduced, by only storing statistical information regarding the signal.

The fitting operation comprises fitting known distributions to the statistical distribution of the sample magnitudes in order to obtain a best fit. For instance a least squares algorithm may be used to generate a measure of similarity. It may be for instance that different Rayleigh distributions or other distributions are fitted to the statistical distribution, and for each a measure of similarity generated. The optimum value of the measure of similarity may be the maximum value, indicating the ‘best fit’, the respective known distribution becoming the matched distribution.

A waveform can be reproduced from magnitude information only in some embodiments of the method. However preferred embodiments further comprise the step of determining a phase distribution from the matched distribution, such that the matched distribution and the phase distribution can be used to synthesise the regenerated signal. This allows in-phase and quadrature components of a signal to be regenerated. Some known distributions are associated with having specific phase distributions. For instance a Rayleigh magnitude distribution (observed when a signal experiences Rayleigh fading as a result of multi path) has a uniform phase distribution. Therefore by determining a Rayleigh distribution as the matched distribution, a uniform phase distribution can be inferred. During synthesis of a regenerated signal, synthesised samples can be generated according to the matched distribution and corresponding phase distribution, to recreate a statistically similar signal waveform. Prior art spectrum analysers only capture magnitude information owing to the wide bandwidth over which they are expected to operate. Prior art signal analysers capture magnitude and phase information of a signal, but only over a narrow bandwidth, owing to the storage requirements. The inventors have shown a method or recording and regenerating full magnitude and phase of a signal that mitigates these storage concerns.

Preferably the step of sorting the samples comprises the step of binning the magnitudes to generate the statistical distribution. Binning provides a convenient means of sorting the samples to allow the statistical behaviour of the magnitudes to be revealed, thereby allowing a fitting operation to be performed. Even more preferable is that the step of binning the magnitudes comprises selecting a bin width according to Scott's Reference Rule. This rule is provided in Equation 1 where ‘w’ represents the bin width; ‘a’ represents the standard deviation of the samples; and ‘N’ represents the total number of samples.

w=3.49σN^{-1/3} Equation 1

It is preferable to optimise the number of bins used to ensure statistical behaviour in the samples is unveiled. Too few bins will not reveal such behaviour, and too many bins will dilute the behaviour. Scott's Rule has been identified by the inventor as useful in identifying optimum bin sizes when applied to received signal samples.

A received signal may have propagated in an unknown environment, and therefore it is unknown which known distribution will best describe the statistical behaviour of the signal. Therefore a plurality of different known distributions may need to be evaluated with a fitting operation, to uncover the true signal behaviour. In some embodiments the known distributions comprise normal distributions, Weibull distributions, Rayleigh distributions and Nakagami distributions. These distributions have been selected by the inventors because they are suitable for modelling electromagnetic signal propagation in realistic environments, and therefore are well suited to fitting to the statistical behaviour of electromagnetic signals. Furthermore these distributions have associated phase distributions which are required for the signal regeneration process.

In some embodiments, the step of sorting the magnitudes comprises normalising the magnitudes. This allows statistical analysis of the samples to be performed. In even more preferred embodiments the step of fitting a plurality of known distributions comprises applying a hypothesis test. Fitting a known distribution to the statistical distribution of samples will always have an uncertainty as a result of operating on a subset of the ‘real World’ received signal. Indeed a number of different known distributions may in fact provide a substantially equal ‘good’ fit to the samples themselves. Hypothesis testing allows a null hypothesis (for instance that the received signal magnitude exhibits a Rayleigh distribution for an assigned confidence interval) to have a measure of similarity such as a probability assigned to it, such that a null hypothesis with an optimum (maximal) probability of being correct can be determined.

A plurality of hypothesis tests may optionally be used, to mitigate the inevitability that some hypothesis tests are more suited to testing particular known distribution profiles, and the precise form of the received signal being processed may be unknown at the time it is received. Even more preferred is that the hypothesis tests comprise Kolmogorov Smirnov, Anderson Darling, Chi Squared and Lilliefors tests. The Kolmogorov Smirnov test is well suited to testing of normal distributions; the Anderson Darling test is well suited to testing normal, exponential, extreme value, lognormal and Weibull distributions; the Chi Squared goodness of fit test is well suited to testing normal distributions, but can be adapted through use of a suitable probability distribution to test other distributions; and the Lilliefors test is well suited for testing normal, lognormal, extreme value, Weibull and exponential distributions. Alternatively any combination of the tests may be used. A confidence interval of 95% or 99% is preferable for the hypothesis testing. The various hypothesis tests may generate a measure of similarity as a ‘p-value’ for each null hypothesis, indicating a probability the null-hypothesis provides the confidence to interpret that the statistical distribution of the samples obeys the respective known distribution.

In some embodiments the step of synthesising a regenerated signal comprises the step of configuring a random number generator to operate with a probability distribution equivalent to the matched distribution, and generating therefrom a plurality of synthesised samples. A random number generator is a convenient operator for automatically generating samples that fit a defined probability distribution. When a matched distribution has been determined, the random number generator can be configured immediately to have a corresponding probability distribution, or alternatively can be configured at a later time prior to generating synthesized samples. The synthesized samples can then arranged as a waveform that can be played back to a unit under test (for instance as an electromagnetic signal in the laboratory).

In some embodiments the step of sampling a received signal comprises the steps of generating a spectrogram of the received signal; and selecting a plurality of samples corresponding to a predetermined frequency. A signal environment, such as real World electromagnetic background, comprises signals at many frequencies, and a communications device under test may require testing against one or more of these frequencies. A subset of frequencies may be selected by thresholding the spectrogram and only processing samples from frequencies where signal magnitude exceeds a predetermined value.

According to a second aspect of the invention, there is provided apparatus for regenerating a signal, comprising transceiver means for receiving and transmitting a signal connected to a means for processing data, wherein the means for processing data is configured to sample a received signal from the transceiver means to obtain a plurality of samples each having an associated magnitude; sort the samples to obtain a statistical distribution of the magnitudes; fit a plurality of known distributions to the statistical distribution using a fitting operation, and in each case obtaining a measure of similarity; determine a matched distribution from the plurality of known distributions, the matched distribution corresponding to an optimum value of the measure of similarity; synthesise a regenerated signal using the matched distribution; and then transmit the regenerated signal using the transceiver means. This apparatus does not require vast amounts of data storage to record and replay a statistically equivalent signal to a received signal, instead only statistical distributions regarding a received signal are obtained and used for signal regeneration. This apparatus is of particular benefit to electromagnetic signal capture and re-synthesis.

In preferred embodiments the means for processing data is further configured to determine a phase distribution from the matched distribution, and then synthesise the regenerated signal using the matched distribution and the phase distribution.

According to a third aspect of the invention, there is provided a computer program comprising instructions which, when the program is executed by a computer, cause the computer to carry out the method of the first aspect of the invention. According to fourth aspect of the invention, there is provided a computer-readable data carrier having stored thereon the computer program of the third aspect of the invention. A computer program or computer-readable data carrier having stored thereon the computer program, are convenient means of implementing the invention on a computer, means for processing data, signal analyser, spectrum analyser, which allows for the installation of computer programs or software, or reading of data carriers (such as CDs, DVDs, permanent memory devices). This may allow the method of the invention to be retrofitted to existing signal capture devices.

### BRIEF DESCRIPTION OF THE DRAWINGS

Embodiments of the invention will now be described by way of example only and with reference to the accompanying drawings in which:

FIG. 1 illustrates for a relatively simple waveform the steps involved in regenerating a signal;

FIG. 2A illustrates the relatively simple waveform operated on using the method of FIG. 1;

FIG. 2B illustrates the results of a fitting operation on the relatively simple waveform of FIG. 2A;

FIG. 3 illustrates for a complex waveform the steps involved in regenerating a signal.

### DETAILED DESCRIPTION

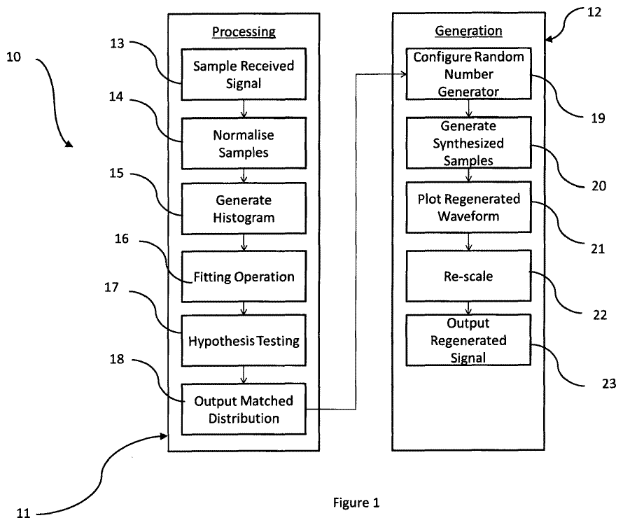

FIG. 1 illustrates an embodiment of a method 10 of regenerating a signal, in flow diagram form. The method 10 comprises two stages: the processing of a received signal 11; and the generation of a regenerated signal 12. In the processing stage 11 a first step comprises sampling a received signal 13 to obtain 400 waveform samples. The received signal is a time based electromagnetic signal, and as such is received by an antenna and transceiver, then sampled by a computer system using an input/output data acquisition card. Each of the 400 samples has an associated magnitude. The waveform samples are normalised in a subsequent step 14 by the computer system to ensure any statistical tests are performed in a consistent manner, and are then processed into a histogram 15 and stored as an array in computer memory. The histogram has a bin width set by Equation 1. Known distributions Normal, Weibull, Rayleigh, Nakagami, are fitted to the histogram 16 to obtain optimally matched versions of each distribution. This is achieved by trialling a plurality of each distribution against the histogram data using a least squares or other fitting algorithm. A plurality of hypothesis tests are then performed 17 with the null hypothesis that the best fitting Normal, Weibull, Rayleigh, or Nakagami, reflects the true statistical behaviour of the received signal magnitude variations with a confidence interval of 95%. The hypothesis tests are Kolmogorov Smirnov, Anderson Darling, Chi Squared, and Lilliefors tests, and are all provided as algorithms within the computer system. Each hypothesis test outputs a measure of similarity in the form of a p-value. The maximum p-value represents the most likely to be true statistical behaviour, which in this embodiment is a Rayleigh distribution. The precise form of the Rayleigh distribution is stored in computer memory as the matched distribution 18. When the received signal needs to be regenerated in the laboratory the second stage 12 of ‘generation’ is performed. This involves configuring a random number generator 19 with a probability density function corresponding to the matched distribution 18. The random number generator is then used to synthesise samples 20 in accordance with the probability density function. These samples can then be plotted 21 as a waveform, and rescaled 22 for instance my multiplying a maximum value of the un-normalised samples. A shape parameter obtained from a maximum likelihood estimate of the un-normalised samples may also be applied. The regenerated waveform may then be played back over-the-air using the transceiver and antenna 23.

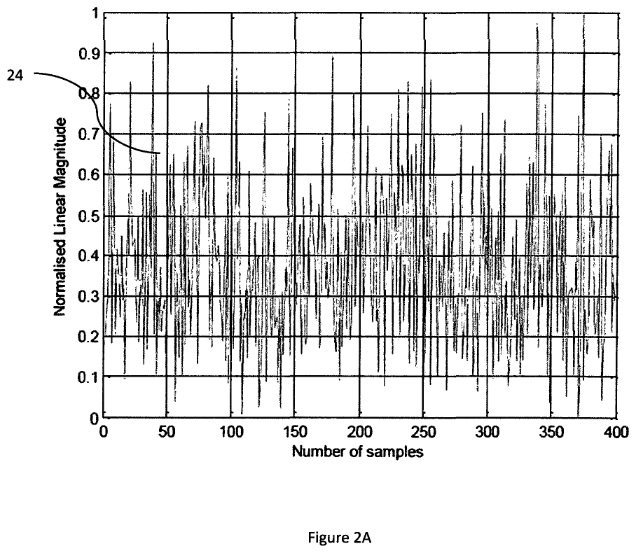

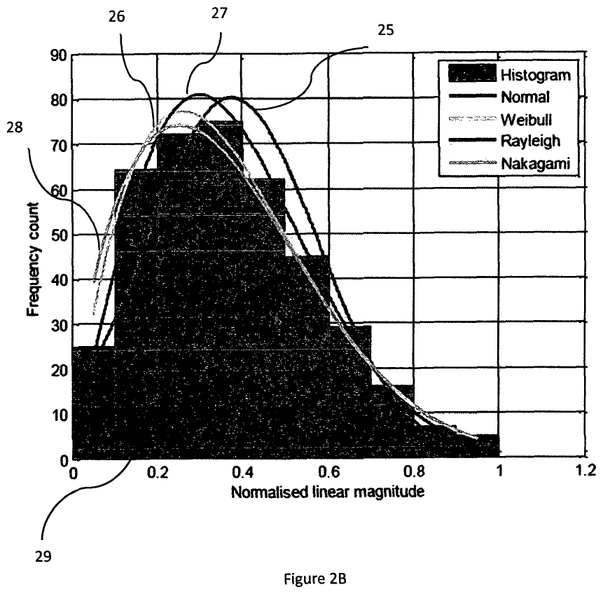

FIG. 2A shows a relatively simple signal 24 received and processed in the method of FIG. 1. FIG. 2B shows the results of a fitting operation applied to the signal 24 of FIG. 2A. An optimal normal 25, Weibull 26, Rayleigh 27 and Nakagami 28, distribution is shown fitted to the normalised binned samples 29, prior to hypothesis testing.

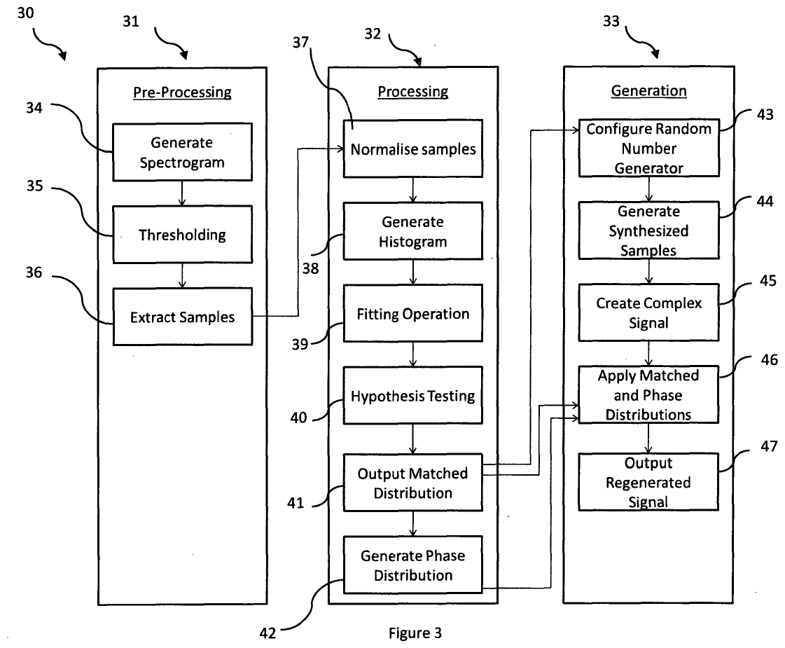

FIG. 3 illustrates for a complex signal the method steps 30 involved in signal regeneration. The method steps 30 are divided into three stages: pre-processing 31; processing 32; and generation 33. Each of stages is performed in a computer system. In the pre-processing stage 31 a spectrogram of an electromagnetic signal is obtained 34. The spectrogram shows the frequencies present in a received signal. The spectrogram is thresholded 35 to identify the frequencies having magnitudes above a predetermined level. This allows the primary frequencies of the received signal to be identified for further analysis (for instance signals above a noise floor). In this embodiment a single frequency is selected for analysis, and the plurality of samples in that frequency bin are extracted from the spectrogram 36 for further analysis. Each of the samples has a respective magnitude, and these magnitudes are normalised 37 in the processing stage 32. The normalised samples are then binned using Equation 1 to generate a histogram 38. A fitting operation 39 is applied to the histogram, using a least squares or other fitting algorithm to fit Normal, Weibull, Rayleigh, Nakagami known distributions to the histogram. Each fitted known distribution is then used in a null hypothesis in Kolmogorov Smirnov, Anderson Darling, Chi Squared, and Lilliefors tests 40, in each case obtaining measures of similarity (p-value). For a given hypothesis test, the known distribution achieving the maximum p-value is deemed to be the distribution representing the statistical behaviour of the received signal at the chosen frequency—the matched distribution. The matched distribution is stored in computer memory 41. In this embodiment the matched distribution is a Rayleigh distribution. The computer system used contains a look-up table matching the known distributions with corresponding phase distributions. A phase distribution is generated using a look-up operation, to associate the Rayleigh matched distribution with a uniform phase distribution (each phase has an equal probability of being present in a given sample) 42. In the generation stage 33, the matched distribution is used to configure a random number generator 43. Synthesized samples are generated by the random number generator 44. A complex signal is generated 45 having both amplitude and phase components, and modulated with the frequency selected from the spectrogram. The synthesised samples are used to scale the amplitude component of the complex signal 46. The phase distribution is used to adjust the phase component of the complex signal 46. The regenerated signal is then output 47 as an electromagnetic signal using an antenna and transceiver.

Complex signals may be generated in the time domain or the frequency domain. A complex signal may comprise many frequencies and the regeneration process may be performed for a plurality of frequencies, the signals being superimposed once regenerated to form a statistically representative version of the received signal. Additional steps of retesting the regenerated signals may be applied prior to their output or transmission. This is to ensure the newly generated waveforms have the same statistical behaviour as the received signal. This may comprise the steps of re-binning the generated samples and applying similar fitting operations as were performed to analyse the received signal.

1. A method of regenerating a signal, comprising the steps of:
a) Sampling a received signal to obtain a plurality of samples each having an associated magnitude;
b) Sorting the samples to obtain a statistical distribution of the magnitudes;
c) Fitting a plurality of known distributions to the statistical distribution using a fitting operation, and in each case obtaining a measure of similarity;
d) Determining a matched distribution from the plurality of known distributions, the matched distribution corresponding to an optimum value of the measure of similarity;
e) Synthesising a regenerated signal using the matched distribution; and then
f) Outputting the regenerated signal.

2. The method of claim 1, further comprising the step of determining a phase distribution from the matched distribution, such that the matched distribution and the phase distribution can be used to synthesise the regenerated signal.

3. The method of claim 1, wherein the step of sorting the samples comprises the step of binning the magnitudes to generate the statistical distribution.

4. The method of claim 3, wherein the step of binning the magnitudes comprises the step of selecting a bin width according to Scott's Reference Rule.

5. The method of claim 1, wherein the known distributions comprise a plurality of different distributions.

6. The method of claim 5, wherein the known distributions comprise a normal distribution, Weibull distribution, Rayleigh distribution and Nakagami distribution.

7. The method of claim 1, wherein the step of sorting the samples further comprises the step of normalising the magnitudes.

8. The method of claim 7, wherein the step of fitting a plurality of known distributions comprises applying a hypothesis test.

9. The method of claim 8, wherein a plurality of hypothesis tests are applied.

10. The method of claim 9, wherein the hypothesis tests are Kolmogorov Smirnov, Anderson Darling, Chi Squared and Lilliefors tests.

11. The method of claim 1, wherein the step of synthesising a regenerated signal comprises the step of a configuring a random number generator to operate with a probability distribution corresponding the matched distribution, and generating therefrom a plurality of synthesised samples.

12. The method of claim 11, wherein the step of synthesising a regenerated signal further comprises the step of arranging the synthesised samples as a waveform.

13. The method of claim 1, wherein the step of sampling a received signal comprises the steps of:
a) Generating a spectrogram of the received signal; and
b) Selecting a plurality of samples corresponding to a predetermined frequency.

14. Apparatus for regenerating a signal, comprising transceiver means for receiving and transmitting a signal connected to a means for processing data, wherein the means for processing data is configured to:
a) Sample a received signal from the transceiver means to obtain a plurality of samples each having an associated magnitude;
b) Sort the samples to obtain a statistical distribution of the magnitudes;
c) Fit a plurality of known distributions to the statistical distribution using a fitting operation, and in each case obtaining a measure of similarity;
d) Determine a matched distribution from the plurality of known distributions, the matched distribution corresponding to an optimum value of the measure of similarity;
e) Synthesise a regenerated signal using the matched distribution; and then
f) Transmit the regenerated signal using the transceiver means.

15. The apparatus of claim 14, wherein the means for processing data is further configured to determine a phase distribution from the matched distribution, and to synthesise the regenerated signal using the matched distribution and the phase distribution.

16. A computer program comprising instructions which, when the program is executed by a computer, cause the computer to carry out the method of claim 1.

17. A computer-readable data carrier having stored thereon the computer program of claim 16.
